(19) United States
(12) Patent Application Publication
(10) Pub. No.: US 2009/0140875 A1
(43) Pub. Date: Jun. 4, 2009

(54) Portable optical signalling device

(76) Inventors: Hendrik Sjirk Wagter, Doorn (NL); Josephus Theodorus Alphonsius Antonius Verbeek, Eindhoven (NL)

Correspondence Address: Dream Control BV/ Opalio, P.O.Box 77, Utrecht, 3500 AB, NL

(21) Appl. No.: 11/915,571

(22) PCT Filed: May 29, 2006
(86) PCT No.: PCT/NL2006/000271

§ 371 Date: Nov. 26, 2007

(30) Foreign Application Priority Data
May 26, 2005 (NL) 1029130

(51) Int. Cl. G08B 5/22

(52) U.S. Cl. 340/815.83

(57) ABSTRACT

The invention relates to a portable optical signalling device, particularly an item of clothing or a flag or a torch, containing:

a signalling component that can be switched between an initial state and a second state, there being a visible difference between the first and second states of the signalling component,

one or more sensors for determining the position of the signalling device or its signalling component and/or variables derived therefrom, and

a control means linked to the signalling component and the sensor or sensors, such control means being designed to switch the signalling component between its first and second states in response to a change in the position and/or the variables derived therefrom being determined by the sensor or sensors.

The invention relates to a portable signalling device, more particularly an optical signalling device, for transmitting an optical, visible signal to the surroundings of the device. More specifically, the invention relates to a portable signalling device or means of expression in the form of illuminated torches, flags, pennants, banners, streamers, ribbons, standards, panels, portable screens, fans, scarves, caps and so forth used for expressing individual and/or collective emotions.

During events where a large audience is present, such as sports matches and pop concerts, people want to be able to express their personal feelings of involvement, excitement, preference or group identity and make them known to third parties. This expression can be both individual and collective in nature. A well-known example is what is known as a “Mexican wave”, in which the individual spectators sitting in the stands at a stadium, for example, act as a group by standing and then sitting in sequence, giving the visual impression of a wave motion that propagates around the stand. This type of expression is mostly accompanied by waving or moving objects such as flags, pennants, streamers, ribbons, standards, boards, scarves, caps or other textile items that have a surface that is visible from a distance that can be moved through the air by one or more spectators.

When used as a means of expression, flags and pennants are often moved together, in a choreographed way or otherwise, so that waving these flags produces a pleasant visual effect for the onlookers. Related to this is the use of ribbons in gymnastics, in which the gymnasts' or dancers' exercises involve moving a holder to which a long coloured ribbon is attached, causing the ribbon to move through the air in an aesthetically pleasing way.

Light-emitting elements that are moved through the air, such as lighters and torches and “rave sticks” are also often used as a kinetic means of expression at events. These illuminated means of expression have the advantage of being visible in dark environments and that rapid movement makes them appear to leave a “light trail”. These means of expression are therefore used during dancing, for example by dancers at a disco.

A disadvantage of the familiar kinetic means of expression is that its expressive capabilities for a user are limited and depend on aspects such as the manual control and manipulation by the user.

One purpose of the invention is to improve this aspect.

To do this, the invention uses a portable signalling device such as that described in claim 1. Advantageous ways of putting it into practice are described in the subsequent claims.

An initial aspect of the invention is that it comprises a portable signalling device, particularly an item of clothing, flag or torch, containing:

a signalling component that can be switched between an initial state and a second state, there being a visible difference between the first and second states of the signalling component,

one or more sensors for determining the position of the signalling device or at least its signalling component and/or variables derived therefrom, and

a control means linked to the signalling component and the sensor or sensors, such control means being designed to switch the signalling component between its first and second states in response to a change in the position and/or the variables derived therefrom being determined by the sensor or sensors.

In contrast to the familiar signalling devices, a signalling device in accordance with the invention can be activated and controlled, with such control preferably being automatic, as a function of a change in the position and/or variables derived therefrom by one or more sensors. The sensor or sensors for this should preferably include a position sensor, velocity sensor, acceleration sensor, a height meter or angle-measuring apparatus.

One implementation of the portable signalling device also contains a receiver or transmitter apparatus connected to the control means for the purpose of connecting the said control means for the signalling device with the control means for one or more further signalling devices.

The receiver and/or transmitter apparatus allows a group of signalling devices in accordance with the invention to be controlled collectively in order to obtain an interplay between the individually movable expression objects. In contrast to familiar signalling devices, the signalling devices in accordance with the invention are suitable for use as a collective means of communication for displaying patterns across a group of signalling devices, by collectively controlling a group of signalling devices in order to allow a variety of changing visual states for the group, e.g. by switching the colour, reflection coefficient and/or light intensity of one or more of the signalling devices within it.

One implementation of the signalling device includes a receiver apparatus and possibly a transmitter apparatus to allow it to be controlled remotely. Such control should preferably be as a function of the absolute and/or relative positions of two or more signalling devices.

In one implementation of the portable signalling device also contains a receiver or transmitter apparatus connected to its control means of the signalling device, for the purpose of connecting the said control means for the signalling device with a central control unit and/or an external network. In one implementation, the signalling devices are controlled by the central control unit or content management unit for processing the source material supplied and/or programming the visual effects that are to be achieved, and for coordinating and addressing the light, colour and/or image fragments for the signalling devices. Preferably, digital or analogue signals from the central control unit are passed on to the signalling devices by means of a wireless radio network. In addition, there should also preferably be a means of determining the absolute and/or relative positions of the signalling devices, with such positional information being input into the content management unit.

The content management unit preferably controls the individual signalling devices to produce static or changing patterns and/or colour effects in the interplay of the individual signalling devices in a group. This means that the devices in accordance with the invention have the advantage that the interplay of the individual signalling devices is controllable under the artistic direction of e.g. an audiovisual content manager to achieve composite visual effects in terms of dynamic representations of colour, light and form. The totality of the individual signalling devices hereby effectively creates a large, moving screen of variable dimensions. The patterns displayed on the composite screen can be colourful static graphical patterns, such as the pattern of a national flag, or a colourful mobile pattern such as the “Mexican wave” that propagates round a stadium.

This method allows a stadium where the spectators on the stands have been given signalling devices in accordance with the invention to form a large screen for displaying patterns of light and sound, even when the audience is not moving as a so-called “Mexican wave”. The spectators here are both viewer and user at the same time. The benefit of this is that it will make the spectators more enthusiastic.

An additional advantage of the device in accordance with the invention is that the composite screen can adopt a very variable scale, shape and spatial dimension, depending on the total number of signalling devices, their positions relative to one another and the absolute positions of the signalling devices with respect to the space within which they are located. If a group of people with signalling devices arrange themselves over either a circular or rectangular area, then the entirety of the signalling devices will display as a large circular or rectangular screen respectively. If a number of the people in this group then go and stand at different heights on a pyramidal platform, then the set of devices will then become a pyramidal screen.

It should be clear that this method allows an infinite variety of screen shapes and sizes to be put together, depending on the height, width and depth of the arrangement.

In one implementation, the signalling device contains one or more sensors, a holder allowing the signalling device to be held and moved, with the holder being fitted with an electronic control means and a means of storing and possibly also generating the electrical energy for supplying the signalling device, plus a means of signalling that is in the holder or fixed to it. The sensor or sensors can in this case be placed in the holder or the means of signalling, connected to it. The electronic control means is connected both to the sensor or sensors and to the means of signalling, so that it can switch the visible state of the means of signalling as a function of the values registered by the sensor or sensors. This produces a direct relationship between the speed of motion, the direction and the position of the signalling device on the one hand with the intensity of the light and/or colour of the means of signalling on the other.

The advantage of this is that users of a signalling device in accordance with the invention can express and emphasise their individual emotions in the movements and in how vigorous they are. An individual signalling device could for example display the colour red when moving to the left and blue when moving to the right. This can for example allow the users to display club colours in an alternating pattern. A signalling device can also be activated from a non-illuminated state into an illuminated one when moved vigorously upwards. If large numbers of users perform this action in sequence, the effect known as the “Mexican wave” can be displayed in any dark or twilit surroundings, for example in the evening. This allows a visual effect to be created in which an illuminated wave propagates round the stadium, possibly also using an alternate colour.

A further advantage of a device in accordance with the invention is that this allows a portable and preferably illuminated signalling device to be obtained with which signals can be transmitted that are directly linked to movement, which can provide an aesthetically pleasant visual image when used in e.g. dance, gymnastics, movement exercises or flag-waving. A device in accordance with the invention can also be used for functional signalling, e.g. for a policeman giving traffic directions.

Coordinated movements of signalling devices in accordance with the invention as a means of expression by a group of users, for example the audience at pop concerts, provides a visually coherent effect that can be observed by both the individual users and by third parties, so that the users of these means of expression will feel part of the whole, which increases the feeling of belonging.

In one implementation, the sensor or sensors include one that is designed to determine a spatial displacement, preferably a relative displacement with respect to a spatial reference network. For this, the control means should preferably be set up to switch the means of signalling from the first state to the second in response to the detection of a spatial displacement. The sensor should preferably contain a position sensor, such as e.g. a GPS (Global Positioning System) sensor or similar.

In one implementation, the sensor or sensors include one that is designed for determining a local movement, preferably an on-the-spot waving motion. For this, the control means should preferably be set up to switch the means of signalling from the first state to the second in response to the detection of a local movement. The sensor should preferably contain a velocity or acceleration sensor.

In one implementation, the sensor or sensors include one that is designed to determine the relative position with respect to another signalling device. For this, the control means should preferably be set up to switch the means of signalling from the first state to the second in response to the detection of a relative displacement.

Each signalling device is fitted with a set of sensors that can record the movement of the signalling device by the user. This set can include one or more of the three implementation variants mentioned above.

In a simple variant, such a sensor arrangement would be fitted with a single cheap bearing sensor for measuring a change in the orientation, or a single accelerometer, preferably made from a piezoelectric material such as a strip of foil. The advantage of such a setup of the sensors is that they are cheap and can easily convert a change in motion into an electrical signal that can be converted by a processor into an action to switch the signalling component of the signalling device on or off or otherwise to address it. In a further variant, the sensor arrangement could be supplied with a gyroscope.

In a further implementation, this sensor apparatus contains piezo-foil or piezo-fibre sensors such as PVDF foils or fibres, with the sensors being applied to a surface of a signalling component such as a flag, for example. These piezo-sensors can switch over and convert the motions of the flag into electrical signals that act as an indicator for motion and/or acceleration, and the said signals can be used to control the signalling device via the means of control.

In a further implementation variant, the sensor device contains a set of sensors so that not only the intensity of the movement but also the direction of motion can be determined.

The signalling devices can adopt different states with respect to the surroundings: horizontal, vertical or diagonal. Determination of the position can therefore be split up into the following components:

determination of position

determination of height

angle measurement

The following options can be applied for carrying out the height measurement: height measurement based on dGPS and CAIROS. The height of the signalling devices will be measurable to an accuracy of centimetres using the existing CAIROS system.

For the angular measurements, sensor systems can be used such as a gyroscope, electromagnetic angle measurers, single-turn angle measurers and optical angle measurement devices. Preferably a combination of tilt sensors and ball-bearing sensors should be used, which are simple and cheap.

The height of the various corners can be measured using a fixed reference surface (e.g. the ground) so that the inclination can be determined, or by angle measurement devices to be fitted to the signalling device itself so that the positioning with regard to at least two or preferably three corners can be combined to give a more accurate angle measurement.

In one implementation, the signalling device is fitted with both the receiver and/or transmitter apparatus and with the sensor or sensors for determining the position of the signalling device (or its signalling component) and/or a variable derived therefrom.

In one implementation, the signalling component contains one or more light sources, preferably of an electroluminescent material such as LEDs, organic LEDs and/or electroluminescent foil.

In one implementation variant, the signalling device contains a signalling component whose reflectivity and/or transmission varies visibly in the first state to the reflectivity and/or transmission in the second state. In one implementation, the signalling component contains an LCD, nano-LCD, cholesteric LCD and/or an electrowetting or electrophoretic material. Since these materials do not themselves emit light, signalling devices using this type of signalling component are energy-efficient, which is beneficial for the active lifespan of the portable signalling devices, which are generally powered by batteries.

In one implementation, the signalling component contains a bi-stable material, such as an electrophoretic material. The first and second states are then both a basically stable state of the material. This means that the material only uses a minimum of energy to retain the first or second state once the material has been brought into that state. Preferably, basically no energy is required to keep these bi-stable materials in either the first or second states. This means that signalling devices made in accordance with this implementation variant are extremely energy-efficient.

In one variant, the colour, greyscale value and/or brightness of the first state of the signalling component differs from the colour, greyscale value and/or brightness of the second state of the signalling component.

In a further variant, the signalling component contains a screen, preferably a matrix screen. This allows images or partial images to be displayed on the signalling component of a single signalling device.

A further aspect is that the invention envisages a central control unit for controlling one or more signalling devices as described above, in which the control unit contains a transmitter for sending a control signal to the signalling device or devices. Preferably, the device should also have a spatial reference network for determining the position of the signalling devices.

In one variant, the spatial reference network contains a number of transmitters, preferably radio frequency (RF) transmitters, that are arranged in a fixed pattern, with each transmitter designed only to transmit the spatial position of the sender within the network on to a signalling device positioned close to the transmitter. A central control unit with a reference network such as this is particularly suitable for use in a composite system where the control signal is sent to all the signalling devices and the control means in the signalling devices contains a means of selection for picking out the data from the control signal that is suitable for and intended for controlling a signalling device that is in the vicinity of a sender.

An advantage of such an arrangement is that it is cheap to implement. An additional benefit is that it can be set up to be independent of the actual moving signalling devices, which therefore remain replaceable.

An example of a composite system like that, implemented in a stadium, would be for the stands in the stadium to be fitted with a first category of short-range RF transmitters, so that the signals from the first RF transmitter are only received by the signalling devices that are placed close to the transmitter in question. At a site such as this, the possible positions for the signalling devices can be predicted beforehand. This initial category of transmitters would preferably be positioned under the seats in the stand so that the seats protect them from the weather and from human actions. This first category of transmitters is placed in a pattern that should preferably match the positioning of the seats in the stand. Each short-range transmitter in this first category regularly broadcasts an identification signal that can be received by a signalling device in its vicinity. The signalling device can use the identification signal to determine its position within the arrangement of first-category transmitters.

The central control unit has a powerful RF transmitter that sends a control signal to all the signalling devices in the stadium. The control data can consist of data for colour, light intensity, sound, vibration, etc. The data is put together by a central content management and then transmitted throughout the stadium as a broadcast transmission covering a large area. Given that the content management knows the locations of all the first-category RF transmitters under the seats, the signalling devices can be controlled as a screen to generate patterns. The frequency used by this powerful transmitter should preferably be different from the frequency used by the first category of RF transmitters under the seats, to avoid interference. The data flow generated by the control transmitter is structured in such a way (e.g. as a DMX simplex signal) that the signalling devices can filter out the data that they need to determine their position from the broadcast signal.

The transmitting antennas of the first category of RF transmitters should preferably be oriented and shielded so that they are directed at the users of the signalling devices and overlap with each other as little as possible, to reduce interference. The first-category RF transmitters should preferably be powered by a (lithium) battery so that the transmitters can continue to operate for several years. One option for this is to charge the battery by a trickle charge mechanism; the energy is then supplied from an external source without wires.

The signalling devices should preferably contain a number of subsystems. Each signalling device actually contains an apparatus with two RF receivers. The first receiver is for reception of the signal transmitted by the first category of RF transmitters, under the seats. The second receiver is in principle for reception of the broadcast signal that is emitted by a powerful RF transmitter in the stadium. The microcontroller is able to use the positional data obtained from the first receiver and used for determining the location to filter the data destined for the particular signalling device out of the broadcast data. A microcontroller in the signalling device then processes this data and the instructions are executed at once or after a predefined delay. This can help synchronise all the signalling devices.

In one variant, the microcontroller can calculate the positional data for the adjacent location areas and then buffer the corresponding control data. If the user of the signalling device now moves from one matrix position to another, the new control instructions are immediately available.

A variant on the first category of RF transmitters is that alternating RF transmitters in a checkerboard pattern transmit at different frequencies, and the first receivers in the signalling devices are able to receive on two frequencies at once. This reduces interference between transmitters. Furthermore, the first receiver can be programmed to use the stronger of the two signals for retrieving the positional data. The signal received by the first RF received contains the positional data sent to the microcontroller.

In a further variant implementation, the spatial reference network contains a number of transmitter/receiver installations, preferably creating a WLAN/network of radio frequency transmitters that are arranged in a fixed pattern. The transmitter/receiver installations are set up for receiving a signal and passing this signal on to an immediate neighbour. The transmitter/receiver apparatus thereby creates a wireless network in which the transmitter/receiver units communicate with each other e.g. using a ZigBee protocol. The transmitter/receiver units are connected to the first category of short-range RF transmitters, which are designed for sending data that is appropriate for and intended for a signalling device that is in close spatial proximity to the first-category transmitter.

A central control unit such as this is particularly suitable for use in a composite system in which the central control unit or the first category of transmitters have a means of selecting the data that is appropriate for and destined for controlling a signalling device before then sending this data to the signalling device in question.

An example of such a composite system used in a stadium could be fitting the stadium's stands with small, short-range RF transmitters of the first category. These first transmitters are arranged in a pattern so that a uniform matrix is created. In this example, the stands in the stadium have cabling to supply power to the first category of RF transmitters under the seats. The first category of RF transmitters also has fixed or wireless broadband network connections to the content management unit, allowing them to be addressed. The first category of transmitters should preferably be designed in such a way that they are very energy-efficient and able to operate for several years on a single battery.

The first-category transmitters are each connected with transmitter/receiver units that communicate with each other by means of e.g. the ZigBee protocol.

The director determines the control data, as in the example implementation variant described above. This is then passed on to various suitably configured transmitter/receiver units under the stand seats via a broadband network. These transmitter/receiver units will then pass it on to the first category of short-range RF transmitters to which the transmitter/receiver unit in question is linked. As the final step, the data is send from this first category of RF transmitters to the signalling devices.

This implementation variant should also preferably use methods of restricting interference, such as shielded and/or directional antennas, different frequencies used for transmitting the control data to the signalling devices (for example the checkerboard configuration mentioned above) and so forth.

In this variant, the signalling device is an installation with a single RF receiver. This receiver is for reception of the signal transmitted by the first category of RF transmitters, under the seats. After this, a microcontroller in the signalling device processes this data and the instructions are executed at once or after a predefined delay. This can help synchronise all the signalling devices.

In a further implementation variant, the spatial reference network contains a number of transponders (e.g. RFID labels) that are arranged in a fixed pattern, with each transponder being designed to pass its spatial location in the network on to a signalling device located in the proximity of the transponder. A setup such as this is particularly suitable for use in a composite system in which the receiver apparatus and/or transmitter apparatus of the signalling devices are designed for reading a transponder near the signalling device and in which the control means include a means of selecting such data from the control signal as is appropriate for and intended for controlling a signalling device that is located close to the position of the transponder.

In one variant, the central control unit also contains a receiver apparatus for receiving data from the individual signalling devices, preferably regarding their positions and/or variables derived from them. The control unit should preferably be designed for sending an individual control signal to each signalling device, with the individual control signal preferably depending on the position of the individual signalling device or on variables derived from it.

A control unit such as this is particularly suitable for use in a composite system in which the signalling devices contain a transponder for identifying the various signalling devices and in which the transmitter/receiver unit in the control unit is set up to read the data from the signalling devices' transponders in order to determine their positions and/or variables derived therefrom. To do this, the central control unit should preferably have a means of selecting the data that is appropriate for and destined for controlling a signalling device at a given position before then sending that data to the signalling device in question.

A further aspect of the invention envisages a communications unit for controlling multiple signalling devices jointly or independently. This communications unit ensures that each of the multiple signalling devices displays a particular type of light, colour or (partial) pattern, with the display of the lights, colours or patterns controlled also depending on the absolute spatial position of the signalling devices or the relative displacement of multiple signalling devices from one another.

Where the multiple signalling devices are worn by the same number of individuals, and the light or pattern of each signalling device is controlled by the controller, this has the benefit of turning the total group of signalling devices into a screen of variable dimensions. The communications unit preferably includes:

a central content management unit directing the processing of the source material being supplied and/or programming the visual effects to be realised, and coordinating and addressing the lights, colours and/or patterns on the signalling devices,

a wireless radio network for transmitting digital or analogue signals from the central control unit or content management unit to the signalling devices,

a mechanism for determining the absolute and relative positions of the signalling devices,

in which the positioning apparatus is continuously measuring and/or determining the absolute and relative positions of the moving signalling devices and passing current information on to the content management unit,

and in which the content management unit subdivides the patterns and signals that are to be displayed on the totality of the signalling devices into individual parts of patterns or subsignals corresponding to the number of signalling devices and their absolute and relative spatial positions, based on information from the positioning unit, and

in which a wireless radio network sends these partial patterns or subsignals to the individual signalling devices from a transmitter located near to or integrated into the content management unit.

For determining the absolute position of the signalling devices and the relative positions of multiple signalling devices with respect to one another, a communications network using radio and/or digital means can be employed. The positioning unit can consist of a combination of existing techniques such as RFID labels, GPS or (d)GPS, GPS demodulated with GSM, UMTS or GPRS. This can also be used with the already well-known positioning system as defined by CAIROS.

As an alternative, the positioning unit can use what is known as a “video capture system” in which the movements of individual users or groups of users of the signalling devices are recorded with a video camera, such movements being recorded by a processor and suitable software and plotted against a virtual distribution of the space in which the users are located into virtual compartments, with the movements and changes within the virtual compartments being translated into a signal, e.g. a MIDI signal, for controlling the control unit.

In one variant implementation in which the signalling device contains a screen, preferably a matrix screen, the signalling devices themselves can be fitted with receivers for broadband signals in order to receive images and audio.

A further aspect of the invention is that it envisages a portable signalling device, particularly a flag or torch, containing:

a signalling component that can be switched between an initial state and a second state, there being a visible difference between the first and second states of the signalling component,

a control means for switching the state of the signalling component, and

a receiver apparatus and/or transmitter apparatus connected to the control means in order to link the signalling device's control means with that of one or more further signalling devices, and to a central control unit and/or an external network.

A further aspect of the invention is that it envisages a portable optical signalling device, particularly an item of clothing, flag or torch, containing:

a signalling component that can be switched between an initial state and a second state, there being a visible difference between the first and second states of the signalling component,

a control means for switching the state of the signalling component, and

a receiver unit connected to the control means in order to link the signalling device's control means to a central control unit, where the control means are designed to control the signalling component based on the signal that is received by the reception apparatus.

In one implementation, the signalling device also contains one or more sensors for determining the position of the signalling device (or its signalling component) and/or a variable derived therefrom, in which the sensor or sensors are connected to the control means and the control means are designed for switching the signalling component between its first and second states in response to a change in the position and/or the variables derived therefrom being determined by the sensor or sensors.

The aspects and measures described and/or demonstrated in the application may also be used separately from one another where possible. The individual aspects such as the sensors, the network control and the central control units and configurations and other aspects can also be the subjects of separate patent claims specifically for the purpose.

The invention will be explained using a number of example implementations as shown in the accompanying drawings. The following are shown:

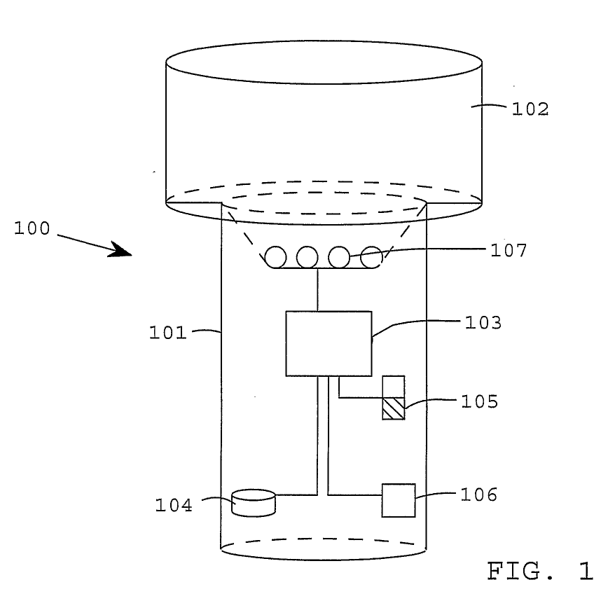

FIG. 1 gives a schematic cross-sectional view of a torch in accordance with the invention;

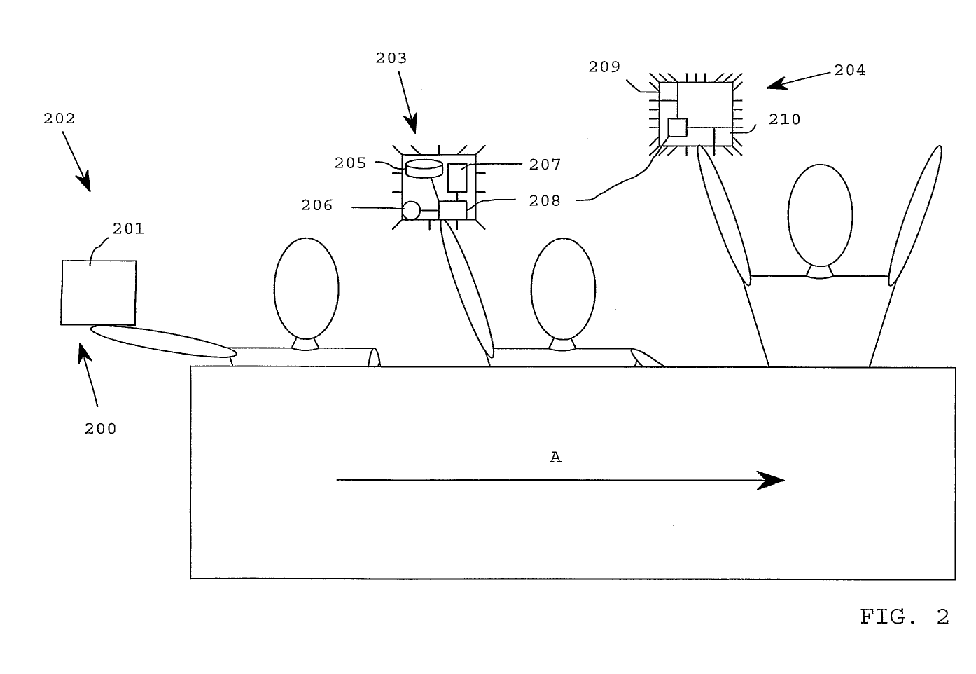

FIG. 2 is a schematic drawing of a flat signalling device;

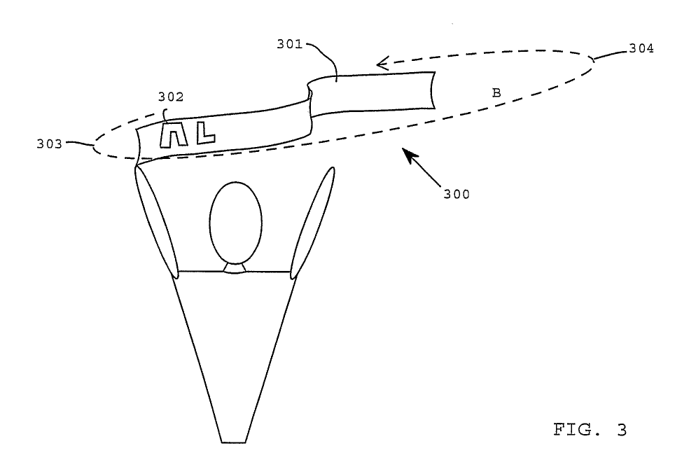

FIG. 3 is a schematic drawing of a scarf or gymnastics ribbon in accordance with the invention;

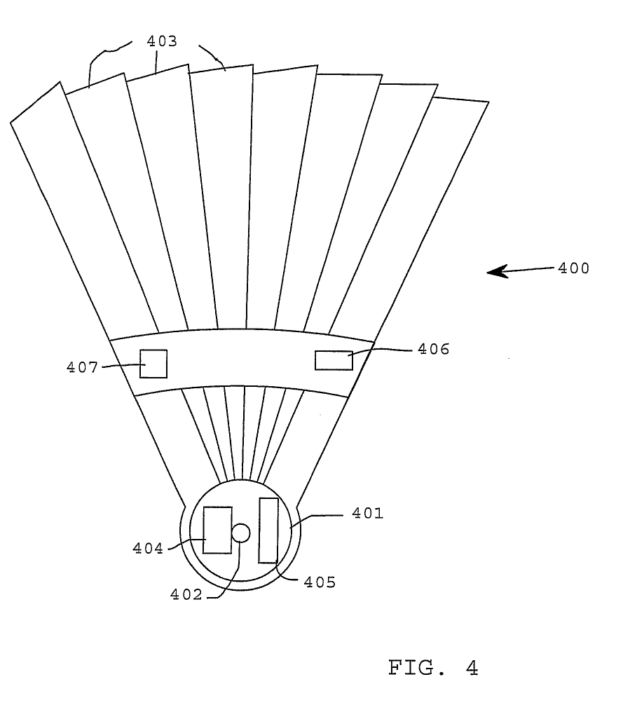

FIG. 4 gives a schematic view of a fan in accordance with the invention;

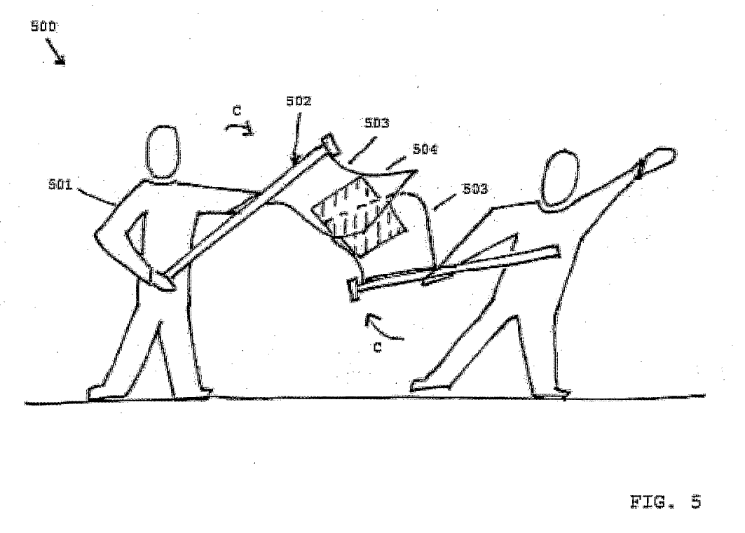

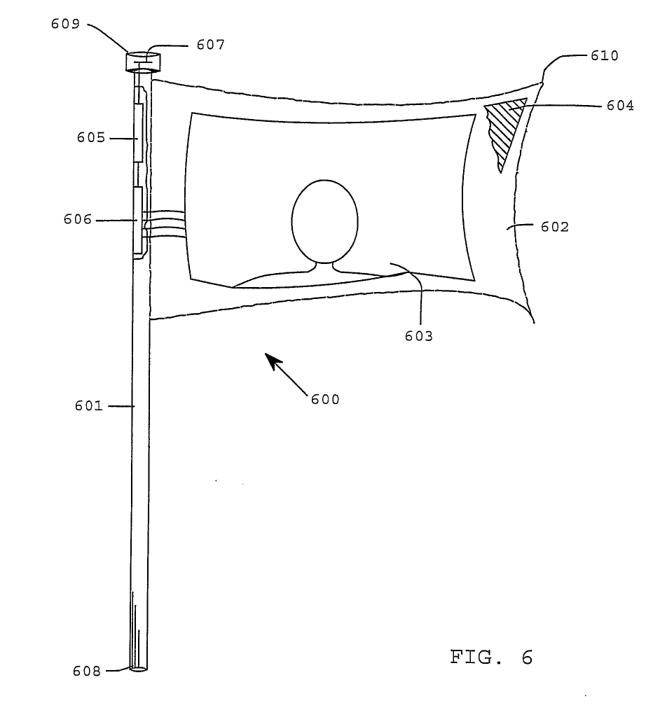

FIG. 5 is a schematic view of deployment of the device in FIG. 6;

FIG. 6 is a schematic diagram, partly in cross-section, of a flag according to the invention;

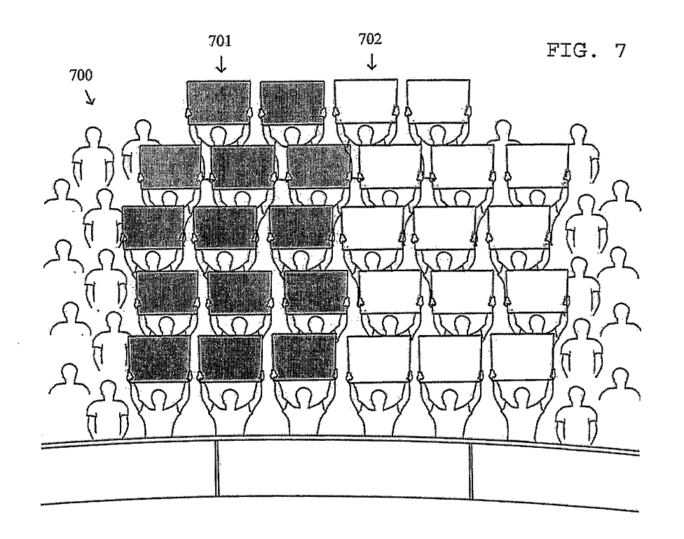

FIG. 7 is a schematic diagram of deployment of the devices from FIG. 2 by a group of users in a stand;

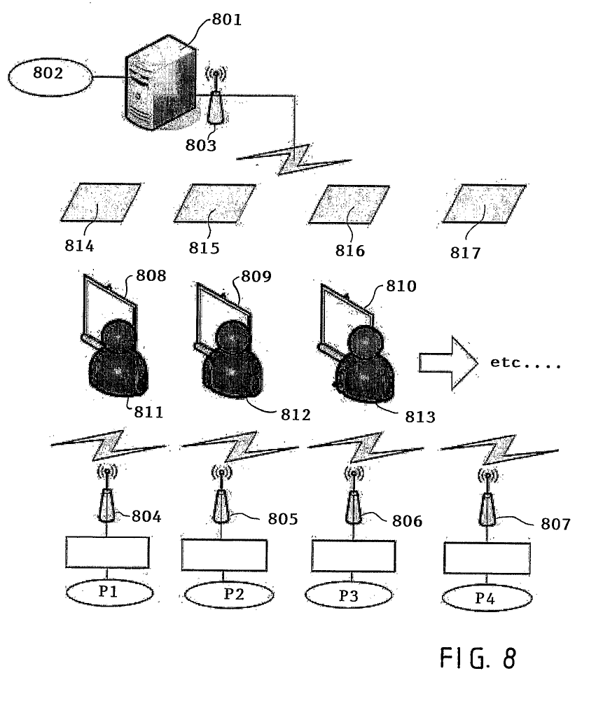

FIG. 8 is a schematic showing the control of a group of devices according to the invention; and

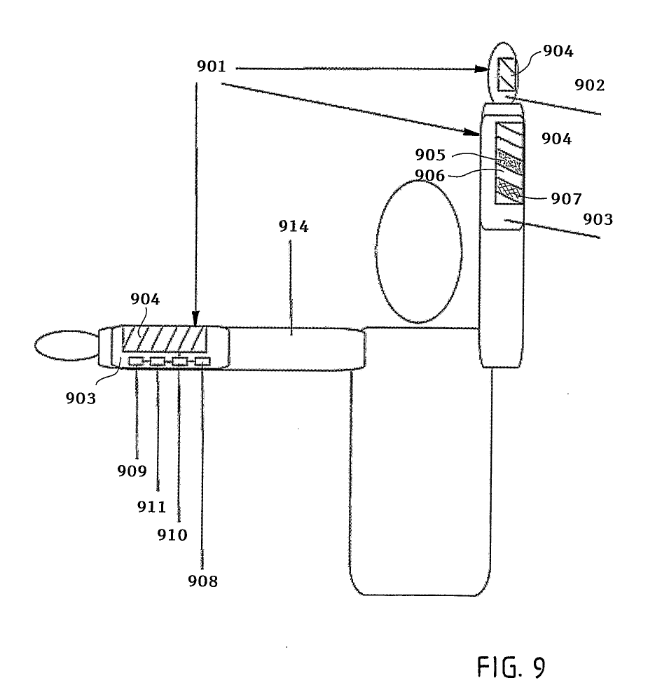

FIG. 9 gives a schematic view of an item of clothing in accordance with the invention, specifically a pair of sleeves and a glove.

In an initial example implementation variant, shown in FIG. 1, the signalling device comprises a torch or illuminated rod 100 fitted with a light source 107, preferably in the form of luminescent elements such as LEDs, PLEDs, OLEDs and so forth in one or several colours. These luminescent elements 107 are placed close to one end of the holder 100.

The torch 100 contains a handle 101 so that a user can hold the torch 100. A light source 107 has been placed at the opposite side to the handle 101.

Emission of light by this light source 107 can at least partly be improved by a reflective or scattering surface 102, for example a mirror and/or window, so that light from the source 107 can be seen from several sides.

The cylindrical holder 100 has a means of storing and distributing energy 104. This implementation variant contains sensors 106 that can register a motion of the holder 100. Sensor 106 is connected to a control unit in the form of a processor 103, so that the sensor 106 can send a signal to processor 103 when it detects motion.

Additionally, the handle 101 has a switch 105 for switching the torch 100 on and off. The processor 103 is also connected to the light source 107 so that it can control it.

In a further development, the torch or illuminated rod 100 can be given a space with a concave exterior where a drink can be placed. The concave space is preferably open at the opposite end to the handle 101 and is shaped e.g. like a beer glass. An electroluminescent foil can be used here, placed in or adjacent to the scattering surface 102 around the holder 100.

In a second example implementation variant, shown in FIG. 2, the signalling device consists of a portable, basically rigid panel 200 with a light-emitting surface 201 that can change its luminosity, colour or image. In a simple variant, a transparent matt panel 200 made of polypropylene or other plastic that scatters light contains one or more LEDs 206 or other light sources, preferably one or more coloured light sources such as LEDs, plus a chip 208 for modifying the colour and/or luminosity. These screens 200 are fitted with sensors 207, in accordance with the invention, for measuring velocity, height, orientation and motion. The screens 200 also have corner sensors 209 and 210 that have been applied to at least two corners of the panel 200. The energy store can consist of an external means of storage 205 such as a battery or similar, preferably an internal means of storage such as a button cell battery. The sensors 207, 209 and 210 and the signals they send to the control unit 208 can allow a screen 200 to be controlled differently in different positions 202, 203, 204. For example, the brightness of the screen image can be a function of the height of the screen 200, so that the brightness increases from a low position 202 to a high one 204.

In a more complex implementation variant, this panel 200 can consist of a flat panel screen of the familiar types, with a rigid frame such as TFT or LCD, or flexible screens such as OLED, PLED or another type.

In a third example implementation variant, shown in FIG. 3, the signalling device consists of a flexible foil, film or cloth, scarf, piece of cloth or ribbon 300, made of a woven or non-woven textile containing luminescent materials such as e.g. electroluminescent polymers.

These textiles can potentially be used in clothing accessories such as a scarf consisting of light-emitting materials such as e.g. electroluminescent polymers that can be switched between an initial dark state and a light-emitting second state. The electroluminescent parts of the scarf can be placed to produce a symbol or logo, as shown in FIG. 3.

The built-in sensors (not shown) in the scarf 300 can be arranged similarly to the sensors, control and battery for the second example variant, allowing the light-emitting materials to be controlled to give different visual effects at different positions 303 and 304. This allows the scarf 300 to emit white light at the first position 303 and red light at the second position 304.

In a fourth example implementation variant, shown in FIG. 4, the signalling device is shaped as a fan 400, preferably folding up in the usual fashion around a pivot 402. The fan 400 should preferably be made at least partly of textile materials. The fan 400 can be used to generate an airflow to cool the user. The fan 400 has light-emitting or colour-changing materials applied to the signalling components 403, which are controlled by a controller 404 as soon as the sensors 406 and 407 in the signalling device 400 detect a motion.

The fan 400 has sensors for determining motion, for example using an accelerometer 407, and position, for example using an angle detector 406. These would preferably be piezo sensors that are woven in. The controller 404 and battery 405 for storing energy are in the holder 401.

In a fifth example implementation variant, shown in FIG. 6, the signalling device is shaped as a flag 600. In other variants the flag 600 could also be a pennant or banner. The flag 600 has a signalling component 603 with a flexible surface—preferably made of electrical polymers, OLEDs, PLEDs, an electrophoretic material (either woven or non-woven) and/or a mesh of textile-like LED lighting—that has been applied to a carrier 602.

Such flags 600 have the advantages that they bend and move elegantly as they interact with the wind, that they can show a changing image varying from a changing colour and/or graphical image through to complete or partial elements of digital videos. By moving this implementation variant as a composite in the wind, a rich graphical representation can be created consisting of a changing digital image that a group of viewers at a distance can see as a show, as shown e.g. in FIG. 5 in which the different flags 502 and 503 are controlled so that each shows a part of a pattern or image, these parts being matched to the relative motions of the flags 502 and 503 so that the partial patterns merge together for a viewer to give the desired pattern 504.

The flag 600 contains a holder 601 to which the carrier 602 is attached. By fitting the flag 600 with a piezo-sensor 604 (for example as a foil, film or matrix of piezo-threads), the speed of motion and changes of direction of the signalling component 603 can be recorded accurately. The microprocessor 605 can also record how many changeover points have been measured. For example, if the flag 600 is waved back and forth several times by the user, then the sensor 604 can record the number of changeovers and this data can be used by the processor 605, resulting in a change of colour or intensity via the image control device 606 after a predefined number of changeovers. This means that actively moving the signalling device 600 results in a changing image or visible signal.

In the flag 600 shown in FIG. 6, the processor 605 and image control unit 606 and the transmitter and/or receiver installation 609 are in the flag's stick. The transmitter and/or receiver installation 609 is placed near the opposite end of the flag's stick 608 to the holder 601, along with an antenna for sending and/or receiving signals from a central control unit.

In this example implementation variant, the flag has three corner sensors 608, 609 and 610 for determining the spatial orientation of the flag 600. Of these, two corner sensors 608 and 609 are located near the ends of the flag's stick and a third corner sensor 610 is near the opposite end of the carrier 602 to the stick.

The piezo-sensor 604 can also be used to detect an infrared signal that can act as an actuator for e.g. switching the signalling component 603 on and off. An advantage or transmitting a signal in this way is that it has a very small bandwidth and can easily be used, especially if a piezo-sensor 604 is already being used for measuring the acceleration of the signalling component 603.

The control unit for a collection of flags 600 contains a high-quality wireless broadband connection that is suitable for sending audiovisual material such as digital video via WIMAX, DAB video or other protocols familiar from video transmission technology.

FIG. 7 shows an application of a group of signalling devices according to the invention, specifically a signalling device as in the second example implementation above, for performing a “Mexican wave”. Other variants of the device according to this invention can also be used for this. The spectators in the stand 700 are encouraged to move the signalling device up and then down again sequentially, in a wave movement than propagates around the stand 700. The upward movement is detected by the signalling devices 701 and they are then switched into a first visual state. In the same way, the signalling devices 702 are switched into the second visual state by a downward motion. It should be obvious that large numbers of variants on this theme are possible.

The diagram in FIG. 8 shows an example implementation of a communications device with a network and a number of signalling devices. For this, a central content management unit 801 for processing the source material 802 is connected to a wireless radio network via a transmitter/receiver apparatus 803. The positioning unit in this diagram is provided by the radio transmitters 804, 805, 806 and 807, which jointly make up a reference network.

The radio transmitters 804, 805, 806 and 807 regularly emit radio signals that can only be read over a short range by a receiver built into signalling devices 808, 809 and 810 that are held by the users 811, 812 and 813. Each signalling device 808, 809 or 810 thus receives information about its position with respect to the reference network.

The transmitter/receiver apparatus 803 in the communications unit's wireless radio network then sends a signal to the signalling devices 808, 809 and 810, such a signal being encoded as a function of the positioning signal as received by the individual signalling devices 808, 809 and 810 and the positioning unit 804, 805, 806 and 807. If signalling device 808 has for example received signal p1 from positioning device 804, it could turn e.g. red. If signalling device 809 has for example received signal p2 from positioning device 805, it could turn e.g. green. If signalling device 810 has for example received signal p3 from positioning device 806, it could turn e.g. blue. In this fashion, the signalling devices 808, 809 and 810 can each act as a pixel in a larger screen.

If the user 813 now moves from point P3 to point P4, the receiver in the signalling device 810 now automatically receives a different signal, from positioning device 807. The signalling device 810 then receives a different signal from transmitter 803, appropriate for that point. This means that the colour of the signalling component of signalling device 810 is modified to match the corresponding signal, e.g. it turns red again. This allows the users of the signalling devices 808, 809 and 810 to move freely with respect to the reference network 804, 805, 806 and 807, while the content management unit 801 can still send the correct signals 814, 815, 816 and 817 to the corresponding signalling devices 808, 809 and 810 associated with the intended locations p1, p2, p3 and p4 in order to create the desired communicated image or audiovisual effect.

Finally, FIG. 9 shows another example implementation in which the signalling device 901 contains an item of clothing or casing that can be placed over a part of the body, such as a glove or mitten 902 that can be placed over the hand or a sleeve 903 that can be pulled on over part of the arm 904, either as a separate clothing accessory or as part of an item of clothing such as a sweater or jacket.

Sleeve 903 consists of a textile sheath with rubber bands or similar that has a signalling component 904 with one or more switchable elements 905, 906 and 907. The sleeve 903 also has one or more sensors 908 such as motion detectors, accelerometers and/or angle measurers plus an energy store 909 and a processor 910 as well as wiring between the energy store 909, the processor 910, the sensors 908 and the signalling component 904 and a switch 911 for turning the signalling device 901 on and off manually. The sleeve can be used to support the signalling function using gesticulatory movements of the said part of the body 904, for example by a (traffic) policeman or air traffic controller who uses arm movements to indicate the desired direction of motion for vehicles such as cars or planes to the drivers or pilots.

The device could for example be set up for the following functions:

arm up: red

arm outstretched: green

arm down: off/orange, or similar.

This has the advantage of producing a natural support for the signal indications without requiring items such as a lamp or torch to be held in the hand, leaving the hands free for other activities.

It should be clear that the example implementations of the invention described above are intended as illustrations of the invention and are not limitative. An expert will undoubtedly be able to design alternative implementation variants that are in the spirit of the invention and that are protected by the scope of the associated claims.

1. A portable optical signalling device, particularly an item of clothing or a flag or a torch, containing:
a signalling component that can be switched between an initial state and a second state, there being a visible difference between the first and second states of the signalling component,
one or more sensors for determining the position of the signalling device or its signalling component and/or variables derived therefrom, and
a control means linked to the signalling component and the sensor or sensors, such control means being designed to switch the signalling component between its first and second states in response to a change in the position and/or the variables derived therefrom being determined by the sensor or sensors.

2. A signalling device in accordance with claim 1, further comprising a receiver or transmitter apparatus connected to the control means for the purpose of connecting the control means for the signalling device with the control means for one or more further signalling devices.

3. A signalling device in accordance with claims 1 or 2, also containing a receiver or transmitter apparatus connected to the control means for the purpose of connecting the control means for the signalling device with a central control unit and/or an external network.

4. A signalling device in accordance with claims 2 or 3 in which the control means have been designed for using the transmission apparatus to send a signal indicating the status of the signalling device and/or the position and/or variables derived therefrom.

5. A signalling device in accordance with claim 2, 3 or 4 in which the control means have been designed for controlling the signalling component based on a signal that is received by the receiving apparatus.

6. A signalling device in accordance with claim 1 in which the sensor or sensors include one sensor that is designed to determine a spatial displacement, preferably a relative displacement with respect to a spatial reference network.

7. A signalling device in accordance with claim 6 in which the sensor or sensors include one sensor that is designed for determining a local movement, preferably an on-the-spot waving motion.

8. A signalling device in accordance with claim 6 in which the sensor or sensors include one sensor that is designed to determine a separation or a relative displacement with respect to at least one other signalling device.

9. A signalling device in accordance with claim 6 in which the sensor or sensors include a position sensor, speed sensor, an acceleration sensor, a height sensor, a gyroscope or device for measuring angles.

10. A signalling device in accordance with claim 1 in which the signalling component contains one or more light sources.

11. A signalling device in accordance with claim 10 in which the signalling component contains and electroluminescent material such as LEDs, organic LEDs and/or electroluminescent foil.

12. A signalling device in accordance with claim 1 in which reflection or transmission by the signalling component is visibly different in the first state of the signalling device to that in the second state.

13. A signalling device in accordance with claim 12 in which the signalling component contains an LCD, nano-LCD, cholesteric LCD and/or an electrowetting or electrophoretic material.

14. A signalling device in accordance with claim 12 in which the signalling component contains a bi-stable material.

15. A signalling device in accordance with claim 12 in which the colour, greyscale value and/or brightness of the first state of the signalling component differs from the colour, greyscale value and/or brightness of the second state of the signalling component.

16. A signalling device in accordance with claim 1 in which the signalling component contains a screen, preferably a matrix display.

17. A signalling device in accordance with claim 1 comprising a holder in which the control means is placed, with the signalling component being positioned in or on the holder.

18. A signalling device in accordance with claim 17 in which the signalling device has a basically transparent casing for the signalling component that preferably scatters the light.

19. A signalling device in accordance with claim 18 in which the device is shaped like a torch, a cup or a bottle.

20. A signalling device in accordance with claim 1 in which the signalling device comprises a flag, the said flag comprises, on one or both sides, the signalling component.

21. A signalling device in accordance with claim 1 in which the signalling device is a covering for parts of the body, such as the head, torso, arms or hands, and in which the signalling device is placed on the opposite surface of the casing to the body contact.

22. A signalling device in accordance with claim 20 or 21, with the flag or covering preferably being made from an electronic fabric or textile, preferably woven from threads of electrophoretic or electroluminescent material.

23. A central control unit for controlling one or more signalling devices in accordance with claims 3, in which the control unit has a transmitter apparatus for sending a control signal to one or more signalling devices.

24. A control unit in accordance with claim 2 or 3 that also contains a spatial reference network.

25. A control unit in accordance with claim 24, in which the spatial reference network contains a number of transmitters, preferably short-range radio frequency transmitters, that are arranged in a fixed pattern, with each transmitter designed to transmit the spatial position of the sender within the network on to a signalling device positioned close to the transmitter.

26. A composite signalling system comprising a number of signalling devices in accordance with claims 2 or 3, plus a central control unit in accordance with claim 25, in which the control means in the signalling devices have a means of selecting such data from the control signal as is appropriate for and intended for controlling a signalling device that is located close to the position of a transmitter.

27. A control unit in accordance with claim 24 in which the spatial reference network contains a first category of transmitters, preferably radio frequency transmitters that communicate with one another and preferably do so using a ZigBee protocol, arranged in a fixed pattern, with this first category of transmitters being designed for sending data that is appropriate for and intended for controlling a signalling device that is in the proximity of the transmitter.

28. A control unit in accordance with claim 24 in which the spatial reference network contains a number of transponders that are arranged in a fixed pattern, with each transponder being designed to pass its spatial location in the network on to a signalling device located in the proximity of the transponder.

29. A composite signalling system comprising a number of signalling devices in accordance with claim 2 or 3 and a central control unit in accordance with claim 28 in which the receiver apparatus and/or transmitter apparatus of the signalling devices are designed for reading a transponder near the signalling device and in which the control means include a means of selecting such data from the control signal as is appropriate for and intended for controlling a signalling device that is located close to the position of the transponder.

30. A central control unit in accordance with claim 23 that also contains a receiver apparatus for receiving data from the individual signalling devices, preferably regarding their positions and/or variables derived from them.

31. A central control unit in accordance with claim 30 in which the control unit is designed for sending an individual control signal to each individual signalling device, with the individual control signal preferably depending on the position of the individual signalling device or on variables derived from it.

32. A composite signalling system comprising a number of signalling devices in accordance with claims 2 or 3 and a central control unit in accordance with claim 30 or 31, in which the signalling devices contain a transponder for identifying the various signalling devices and in which the transmitter and receiver apparatus in the control unit is designed for reading the transponders in the signalling devices in order to determine their position and/or variables derived therefrom.

33. A portable signalling device fitted with one or more of the measures described in the attached description and/or the attached drawings.

34. A central control unit fitted with one or more of the measures described in the attached description and/or the attached drawings.

35. A working method containing one or more of the characteristic steps described in the associated description and/or in the associated drawings.
